(19) United States
(12) Patent Application Publication
(10) Pub. No.: US 2004/0158730 A1
(43) Pub. Date: Aug. 12, 2004

(54) Running anti-virus software on a network attached storage device

(75) Inventor: Soumitra Sarkar, Cary, NC (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/364,043

(22) Filed: Feb. 11, 2003

(51) Int. Cl. H04L 9/00

(52) U.S. Cl. 713/200

(57) ABSTRACT

There is provided a method for running anti-virus software for a file system that is accessible by a client through a server. The method includes (a) creating a current point-in-time copy (PiTC) of the file system, (b) determining whether a file in the file system is changed, based on a difference between the current PiTC and an earlier PiTC of the file system, and (c) determining whether the file is to be examined by the anti-virus software, based on whether the file is changed.

### BACKGROUND OF THE INVENTION

1. Field of the Invention

The present invention relates to antivirus software, and more particularly, to a technique of running anti-virus software on a network attached storage device.

2. Description of the Prior Art

A Network Attached Storage (NAS) device is a file server on a computer that serves files to other computers, for example, a user desktop or an application server. The NAS device operates remotely from the other computers using a network file access protocol such as Common Internet File System (CIFS) or Network File System (NFS).

Such a network file access protocol, also referred to as a remote file access protocol allows a first computer to access a file from a second, i.e., remote, computer, and is to be contrasted with a local file access where the first computer accesses a file stored in either a local disk, or a disk accessed remotely via a Storage Area Network (SAN), but where the file system software always runs on the local computer. Many, but not all, remote file access protocols are built on top of a networking protocol known as transmission control protocol/Internet protocol (TCP/IP), which is fundamental to the operation of the Internet.

A “file system” is an abstraction built on top of blocks of data stored in a disk (locally or SAN-attached), which provides a name space consisting of a hierarchy of directories (folders on Windows™) and files and related system information that is a unit of access. On Windows™ for example, a local file system corresponds to data available through a drive letter, e.g., C:, mapped to a disk partition, whereas a network or remote file system could be accessed as a CIFS share such as “\\myServerName\myShareName.” These are files or resources one can access over the network. Every network accessible resource has a name and is often referred to as a “share” since the resource is shared with other computers over the network.

One manner of remote file access is a Windows share accessed using “Microsoft Networking”. For example, using “Windows Explorer” on a Microsoft™ Windows™ 2000 operating system, a user of a client computer can use a “Map Network Drive” option to remotely access a file or a directory from a Windows™ server. From the perspective of the user, the accessed file or directory appears to be local and a file system is “rooted” at a drive letter on the client computer.

A major benefit of a NAS system is file sharing. A NAS server can provide remote file access to potentially thousands of other computers, i.e., NAS clients.

Unfortunately, a client in the NAS system, e.g., a desktop system, can be infected by a computer virus, which the client may have received, for example, via electronic mail (email). The virus resides in an infected file on the client. In addition to the danger of the virus propagating to other computers via email, the infected client can spread the virus by storing the infected file in a shared file system. The virus could then propagate to other computers that have access to the same file system. Thus, it is desirable for the NAS system to ensure that all files stored in it are free of computer viruses.

Antivirus (AV) software may prevent the propagation of viruses. A virus signature is a pattern of 1's and 0's that represent code for a virus. AV software includes logic to examine files for known virus signatures and quarantine those files if a known virus is detected. A vendor of AV software can differentiate its AV software from that of other vendors based on:

(1) completeness of its virus signature file, where it is most preferable for the virus signature file to contain signatures of the most recently discovered viruses;

(2) computational efficiency of the AV software with regard to examination of files for virus signatures.

For a desktop client accessing files on locally attached disks, AV software runs on the client itself. However, in a shared file system environment where potentially thousands of desktop clients are accessing the same files on a NAS over a network, it is not practical for individual clients to run AV software on shared files.

Having clients run AV checks on network accessed files is extremely inefficient since each client would check a file it is accessing even if another client had accessed the same file moments earlier, already checked it, and had not modified the file after the check. Besides duplication of effort, if a client periodically checks an entire shared file system, e.g., executing AV software in a batch mode as described below, a tremendous amount of network traffic would be generated as the files are remotely accessed. If multiple clients all repeat this work periodically, the inefficiency multiplies. Accordingly, in an environment with a NAS system providing network file access to many clients, for maximum efficiency, all AV checking is preferably performed on a the NAS server.

AV software packages run in two fundamentally different modes, namely batch mode and incremental mode.

In batch mode, the AV program (periodically) scans all files in an entire file system, e.g., a drive letter on Windows™. It examines each file for viruses by looking for virus signatures in that file. For a large file system for example, one that is several gigabytes (GB, billions), or perhaps several terabytes (TB, trillions) in size, this can take an extremely long time. It is not safe to merely note the last time the AV program was run in batch mode, and then only scan a file having a change-time attribute that indicates that the file was modified after the AV program was last run. This is because typical operating systems provide application programming interfaces (APIs) that can change such an attribute, irrespective of whether the file is accessed locally or remotely, and therefore a virus can modify the change-time attribute of the file and fool any such selective scanning logic.

In incremental mode, the AV program has “hooks” into low level file system code for a given operating system, and scans a file for virus signatures in one of two modes:

(1) When a file is opened (for reading or writing). The entire file is scanned before even a single byte of the file is delivered to a program that requested the file.

(2) When the file is closed (after reading and/or writing is completed). For reasons of efficiency, it is not feasible to continuously scan a file as each byte of it is modified.

In incremental mode, while an AV program may scan files during file open or close operations, a virus may insert itself into an existing file but not close the file, thus avoiding the AV check from being triggered. Consequently, other readers of the file, e.g., desktop clients accessing the file on a NAS, will end up executing the virus. There does not appear to be any AV software that can handle such a situation, but a file that is always open is typically not useful as a virus since it ordinarily must be closed for the operating system to be able to open it as an executable file and execute the virus' logic, so this situation is not a serious threat.

Typically, batch mode and incremental modes of AV checking are combined in ways that a customer finds to be suitable. For example, a typical AV configuration involves batch mode checking of entire file systems on a once-a-week schedule, and in addition, turning on incremental mode checking either on file open, or file close, or both. Since the schedule for AV software to update its virus signature file (from the AV vendor's Web site, say) typically does not coincide with the schedule for running batch mode updates, it is possible for undetected viruses to remain in files when a file is opened, or closed, or both. Therefore, a mix of both batch and incremental checks is often performed.

There is thus a need for a more efficient technique for executing AV software.

### SUMMARY OF THE INVENTION

A first embodiment of the present invention is a method for running anti-virus software for a file system that is accessible by a client through a server. The method includes (a) creating a current point-in-time copy (PiTC) of the file system, (b) determining whether a file in the file system is changed, based on a difference between the current PiTC and an earlier PiTC of the file system, and (c) determining whether the file is to be examined by the anti-virus software, based on whether the file is changed.

Another embodiment of the present invention is a system for running anti-virus software for a file system that is accessible by a client through a server. The system includes a processor for (a) creating a current point-in-time copy (PiTC) of the file system, (b) determining whether a file in the file system is changed, based on a difference between the current PiTC and an earlier PiTC of the file system, and (c) determining whether the file is to be examined by the anti-virus software, based on whether the file is changed.

The present invention also contemplates a storage media containing instructions for controlling a processor for running anti-virus software for a file system that is accessible by a client through a server. The storage media includes (a) a program module for controlling the processor to create a current point-in-time copy (PiTC) of the file system, (b) a program module for controlling the processor to determine whether a file in the file system is changed, based on a difference between the current PiTC and an earlier PiTC of the file system, and (c) a program module for controlling the processor to determine whether the file is to be examined by the anti-virus software, based on whether the file is changed.

### BRIEF DESCRIPTION OF THE DRAWINGS

FIG. 1 is a block diagram of a NAS system configured for employment of the present invention.

FIG. 2 is a flowchart of a method for running AV software in batch mode, in accordance with the present invention.

FIG. 3 is a flowchart of a method for running AV software in incremental mode, in accordance with the present invention.

### DESCRIPTION OF THE INVENTION

Batch mode checks are typically very expensive, since in all existing AV software that is currently available, all files in the file system are scanned. If batch mode AV checking could be made extremely efficient, thus making it possible to run batch mode checking very frequently (say, every 5 minutes), and if the file access patterns for the NAS (for a given file system) are such that while a large number of files are created frequently, they are not accessed until much later after their creation time, then a possible AV checking configuration could be:

1. Configure batch mode AV checking to run every 5 minutes. This could be done on a low priority (operating system) process to not interfere with the core file serving function of the NAS.

2. Configure incremental AV checking so that files are on not scanned for viruses on the close operation. This would speed up applications that create/modify files since execution of the applications would not be slowed down by virus checking that occurs as modified files are closed.

3. Configure incremental AV checking so that files are scanned for viruses when opened. This would check files that have been modified, and are being reopened (say, for reading, by another application that takes the created/modified file as input) before the batch mode scan has checked them. If most files are not read after creation/modification before 5 minutes, this should be rare.

An embodiment of the present invention is a method in which batch mode AV checking is extremely efficient, even for very large file systems. Unlike file modification timestamp-based mechanisms that are not secure (i.e., virus-proof), the present invention provides for a secure technique for determining a “delta” and allows for batch mode AV checking to be performed only on files that have actually been changed between subsequent executions batch mode AV checks.

In a NAS system environment, to maximize efficiency, all AV checking should be performed on a NAS server. In accordance with the present invention, the NAS server takes advantage of a feature known as a point-in-time copy (PiTC) of a file system, and optimizes AV batch processing.

A PiTC is a point in time, immutable view of an entire file system (folders and files) that represents the state of the file system at the instant the PiTC was created. A PiTC is also referred to as a file image capture. The PiTC of a file system can be represented and accessed in multiple ways. For example, on a Windows™ system where a drive letter, e.g., X, represents a network accessed file system, a PiTC of the file system accessed via X: can be accessed in either of two ways:

(1) Via another drive letter, e.g., Y.

(2) As a subdirectory that appears under a root folder (“\”) of the file system represented by X. For example, the subdirectory could be named based on a PiTC creation day, such as “pitc_{—}1012002”.

In either case, the folders and files under an active file system (e.g., “X:\”) and under the PiTC “root” (e.g., “Y:\”, or “X:\pitc_{—}01012002”, depending on how the PiTC is presented for access) are identical at the instant the PiTC is created. The “active file system” is the “main” file system that is being actively accessed and modified by the user. On a Windows™ machine for example, the file system accessed via C: is the active file system, which is to be differentiated from PiTCs of that file system, regardless of how it is accessed (D:, C:\pitc_{—}010100, etc.). Though this does not always have to be the case, PiTCs are read-only, whereas the active file system is typically available for both reading and writing. More fundamentally, PiTCs are always derived from the active file system as the source. Every file system provides a hierarchical name space, and since every hierarchy has a root, e.g., C:\, every file system has a root. Since a PiTC is a view of a file system at a given point in time, it too has a root. The PiTC feature is provided by several commercial file system products. For example, Network Appliance's WAFL file system provides the Snapshot™ feature, IBM Transarc's DFS file system provides the cloning feature, and IBM's General Parallel File System (GPFS) provides a PiTC feature, all of which are functionally very similar to each other.

A NAS server that employs the PiTC feature in its physical (local) file system, i.e., the file system that it exports to NFS or CIFS clients for remote/network access, keeps track of the state of a file system at various points in time when different PiTCs are created. This is done because, as the files and folders in the active file system are modified, the original data has to be preserved so that a client using a given PiTC can access the original data. Given that such logic is integral to the implementation of the PiTC feature, it is a simple extension for a file system to keep track of the differences between any pair of PiTCs, or between a PiTC and the active file system. Such differences could consist of information such as:

i. Which files have changed in terms of their content, between the pair.

ii. Which files have changed in terms of their attributes, between the pair.

iii. Which files have been newly created and did not exist in the older PiTC.

iv. Which files have been deleted and are no longer present in the newer PiTC (or active file system).

v. Which files have simply been moved from one directory (folder) to another, but have not been modified.

Space required by the PiTC is proportional to the changes made to the active file system since the PiTC was created. PiTC implementations typically use “copy on write” techniques. When a PiTC is first used, it requires minimal space, to simply record the fact that the files and directories in the PiTC are identical to that of the active file system. As files and directories in the active file system are modified, the original data prior to each modification has to be associated with the PiTC, which means that space has to be allocated (on the disk) to maintain the original data in addition to the new/modified data. This newly allocated space to keep the original data associated with a PiTC is “charged” to the PiTC. Thus, the space allocated for a PiTC is proportional to the changes made to the active file system since the PiTC was created. Thus, the space required by the PiTC is typically less than the space occupied by the active file system for which the PiTC is taken.

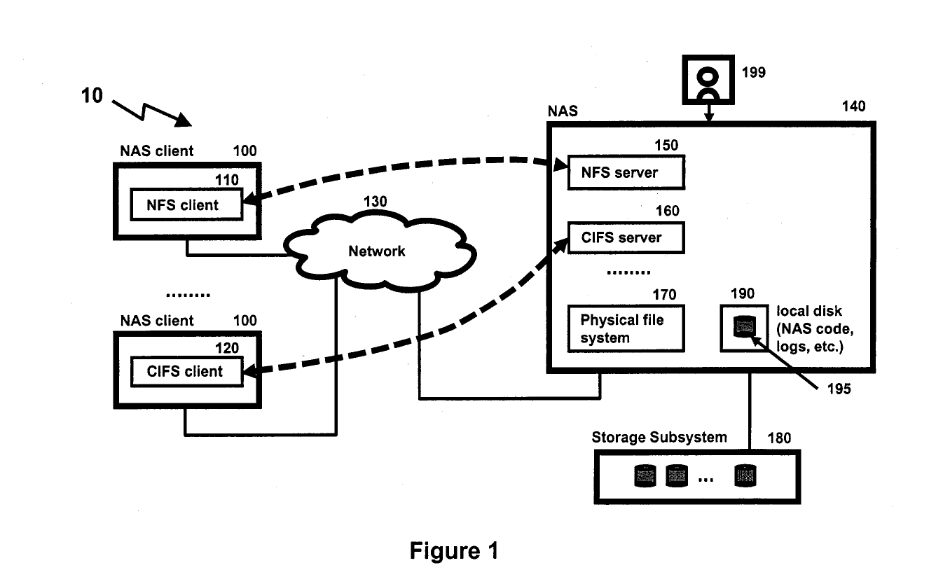

FIG. 1 is a block diagram of a NAS system 10 configured for employment of the present invention. NAS system 10 includes a NAS server 140 and NAS clients 100, all of which are coupled to a network 130. Network 130 is a TCP/IP network, and may be a private intranet, the Internet, or a combination thereof.

NAS server 140 includes a processor (not shown) and memory components for holding an NFS server 150, a CIFS server 160, a physical file system 170 and a local disk 190. NAS server 140 is also attached to a storage subsystem 180, which could be direct attached, e.g., accessed via a Small Computer System Interface (SCSI) protocol, or SAN attached, i.e., accessed using the Fibre Channel protocol that encapsulates the SCSI protocol.

NFS server 150 and CIFS server 160 are two network access protocol servers running on NAS server 140. They are software components that may also be integral parts of an operating system running on NAS 140. Note that NAS server 140 is not limited to employment of these particular network access protocol servers, but instead may also include any suitable number and type of such protocol servers.

A file system abstraction with its hierarchical name space is a virtualization of the more basic representation of 1's and 0's on disks stored in 512 byte sectors. Physical file system 170 is an abstraction of 0's and 1's on a disk, either local or SAN-attached, and may be a component of the operating system running on NAS server 140. Physical file system 170 is a software component that implements a file system abstraction on top of the bits and bytes of data on storage subsystem 180, to represent the data as files and folders. A network file system access protocol is a higher lever abstraction implemented by server software such as NFS server 150 or CIFS server 160, which serves the content of physical file system 170 over network 130. Physical file system 170 is enabled to provide a PiTC of a file system. Physical file system 170 also provides features to track differences between a pair of PiTCs, or between a PiTC and the active file system, and provides an API to determine these differences. Additionally, physical file system 170 provides a special purpose file system attribute that cannot be modified using any network file system access protocol via a standard file system API.

Storage subsystem 180 contains one or more disk drives for storing data, such as customer data files. More particularly, storage subsystem 180 contains the data corresponding to a file system that may be infected by a virus. The present invention seeks to ensure the integrity of this file system by scanning for viruses using standard AV tools, but employs a technique using PiTC capabilities to make such scans faster when run in batch mode.

In a high-end version of a NAS server 140, storage subsystem 180 employs a redundant array of independent disks (RAID) feature for reliability. Although shown in FIG. 1 as being directly connected to NAS server 140, storage subsystem 180 can be external to NAS server 140, in a SAN. Preferably, such a SAN is attached to NAS server 140 via a fiber channel connection for high-speed data communication.

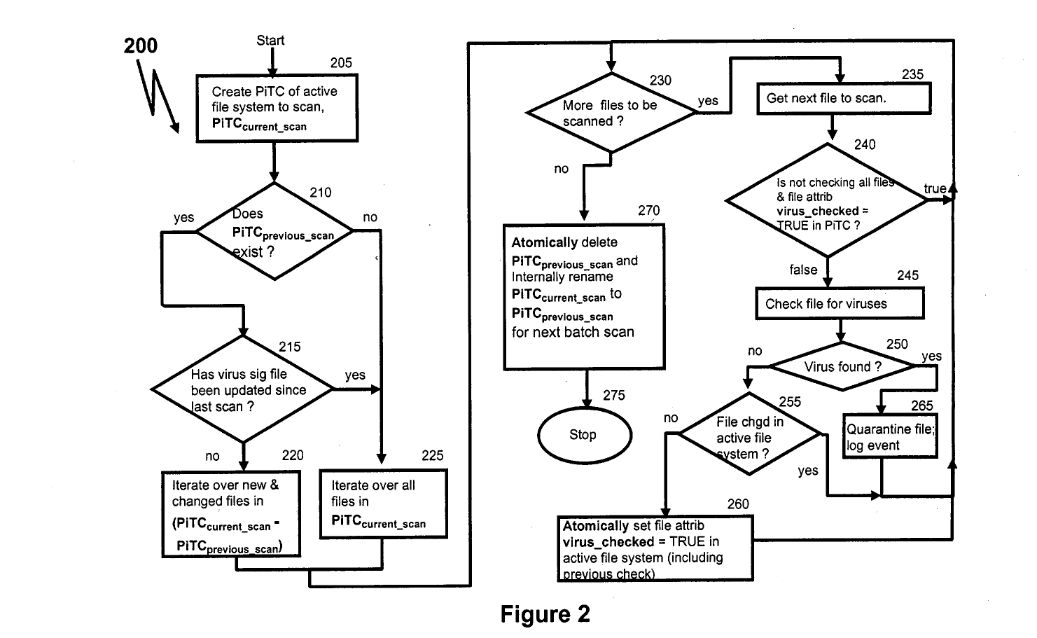

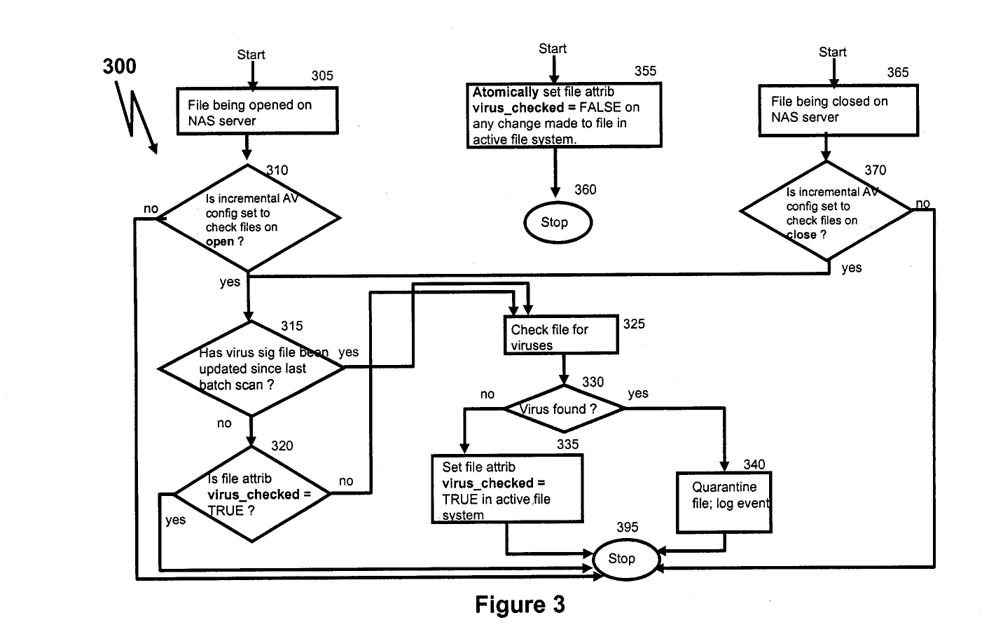

Local disk 190, which may be one of a plurality of such local disks, is for storage of executable NAS code and system logs. Local disk 190 includes a program module 195 that contains instructions to control the processor of NAS server 140 to execute a method for running AV software in accordance with the present invention. Program module 195 is described below, in association with FIG. 2 and FIG. 3. In practice, program module 195 may be organized as a plurality of sub-modules, which collectively provide the instructions for the method. Local disk 190 is deliberately kept separate from storage subsystem 180.

Although system 10 is described herein as having the instructions for the method of the present invention installed into NAS server 140, the instructions can reside on an external storage media 199 for subsequent loading into NAS server 140. Storage media 199 can be any conventional storage media, including, but not limited to, a floppy disk, a compact disk, a magnetic tape, a read only memory, or an optical storage media. Storage media 199 could also be a random access memory, or other type of electronic storage, located on a remote storage system and coupled to NAS server 140.

NAS clients 100 remotely access files from NAS server 140, via network 130. Each NAS client 100 runs a “client” portion of a network file access protocol, e.g., an NFS client 110 or a CIFS client 120. Accordingly, NFS client 110 interfaces with NFS server 150 and CIFS client 120 interfaces with CIFS server 160.

The present invention operates in accordance with the following set of assumptions:

(1) NAS server 140 controls all AV checking. Individual NAS clients 100 do not perform AV checking on shared files accessed via a network file access protocol.

(2) The actual scanning of a given file could be performed either on NAS server 140 itself or on a separate system (not shown) to which a given file is shipped.

(3) A special file attribute that cannot be manipulated using standard file system APIs is provided by physical file system 170. The special file attribute is for reliably marking a file, in a virus-proof manner, to indicate that the file has been scanned and not modified since the scan.

(4) Program module 195, shown in FIG. 1 as being stored in local disk 190, is immune to viruses. Program module 195 effectively executes in a “closed box” that does not communicate with other open systems, and does not receive email with potentially dangerous virus attachments.

(5) NAS server 140 never executes files from storage subsystem 180.

Given this set of assumptions, program code 195 cannot be infected by a virus. Note however, that storage subsystem 180 may potentially be infected with a virus file.

The present invention recognizes that batch mode AV scanning time can be reduced by using the capabilities of physical file system 170 to (a) create a PiTC, and (b) determine whether a file's content is changed or is newly created between two PiTCs, or between a PiTC and an active file system, and (c) maintain a special “system” attribute that is not modifiable by standard file system APIs.

The present invention improves the performance of batch mode execution of AV scanning and recognizes that if a file that is scanned and deemed to be free of any known viruses can be reliably marked as being virus free, for example, by using a reserved file attribute not accessible via a standard file system API, and if the file is to be subsequently served to a NAS client 100, then an incremental check of the file can be avoided if the reserved attribute indicates that the file is virus free. The present invention considers whether a new virus signature file containing new virus signatures has been downloaded to NAS server 140 since a batch mode AV scan of an entire file system was last completed. In that case, all files should be incrementally checked again before being served, because the previous batch mode scan did not check for the new virus signatures.

FIG. 2 is a flowchart of a method 200 for running AV software in batch mode, in accordance with the present invention. Method 200 is embodied as a set of instructions in program module 195. It is invoked when an administrative command on NAS server 140 is executed to perform a batch mode AV scan of a file system. Note that the administrative command can be set up to run periodically, e.g., every 5 minutes, using operating system-specific periodic job schedulers that are commonly available, e.g., “cron” jobs in a Unix-style operating system.

Method 200 uses a special attribute, referred to herein as “virus_checked”. Each file in the file system has an associated “virus_checked” attribute. The “virus_checked” attribute is introduced for reliably marking the file, in a virus-proof manner, to indicate that the file has been scanned and not modified since the scan. For a file, if “virus_checked”=FALSE, then the file is not assumed to have been scanned for viruses. If “virus_checked”=TRUE, then the file has been scanned and no known virus was detected. The “virus_checked” attribute cannot be manipulated using standard file system APIs. For example, “virus_checked” cannot be manipulated by software from NAS clients 100. Preferably, “virus_checked” can only be modified by operating system kernel level software that exists in conjunction with physical file system 170. Method 200 starts with step 205.

In step 205, NAS server 140 creates a PiTC of the file system. Although the capability to create the PiTC is described herein as a feature of physical file system 170, the capability may be provided by any suitable software component of NAS server 140. This newly created PiTC is referred to as PiTC_{current}_{_{—}}_{scan}.

PiTC_{current}_{_{—}}_{scan} is an immutable copy of the active file system, and all batch mode AV checking of files in the file system will be done based on PiTC_{current}_{_{—}}_{scan}. A file in a PiTC can be accessed for reading even if the file in the active file system is being modified. This ensures that if the AV scanning software wants to access a file, it can do so even if another software application has locked the file in the active file system (using standard file system APIs) and is reading or modifying the file. Method 200 then progresses to step 210.

In step 210, a check is performed to determine whether the present execution of the batch mode AV scan is a first ever such execution performed on the present file system. This can be done by checking for the existence of a PiTC named PiTCₚᵣₑᵥᵢₒᵤₛ_{_{—}}_{scan}. PiTCₚᵣₑᵥᵢₒᵤₛ_{_{—}}_{scan} represents an earlier PiTC of the file system, if one was created, which would be the case after the first batch mode AV scan is successfully completed. Note that if PiTCₚᵣₑᵥᵢₒᵤₛ_{_{—}}_{scan} does not exist, then the entire file system is scanned, and the AV scan that is about to be performed will be the first-ever AV batch mode scan. On the other hand, if PiTCₚᵣₑᵥᵢₒᵤₛ_{_{—}}_{scan} does exist, then the present AV scan is not the first AV scan of the file system, and the present scan, which is about to be performed, will examine only the files that have actually changed since the last AV scan. If PiTCₚᵣₑᵥᵢₒᵤₛ_{_{—}}_{scan} does not exist, then method 200 branches to step 225. If PiTCₚᵣₑᵥᵢₒᵤₛ_{_{—}}_{scan} does exist, then method 200 progresses to step 215.

In step 215, a check is performed to determine whether the virus signature file has been updated since the last AV scan.

Note that if the virus signature file has been updated, then the virus signature file may now recognize a virus that was not recognizable the last time the AV software was executed. There may exist a file that was previously infected by a virus, but the AV software could not detect the virus on an earlier run because the signature of that virus was not represented in the virus signature file. Accordingly, the entire file system, including files that have not been not updated since the last AV scan, will be rescanned to account for this case.

On the other hand, if the virus signature file has not been updated since the last AV scan, then for the present AV scan that is about to be performed, the AV software can scan only files that have been updated or newly created since the last AV scan. As previously described, determining whether to scan a file based on a simple file-date-change attribute is not secure against a virus, because the virus running on a NAS client can always modify the modification time attribute of a file after infecting that file by using standard file system operations. However, creation of PiTCs and computing the difference between two PiTCs is controlled by the physical file system 170 and cannot be subverted by a virus running on NAS system 10. Accordingly, method 200 allows the AV software to check a subset of the files in the file system, and yet still ensures that all of the files are still virus-free after the end of the batch mode AV scan.

If the virus signature file has been updated since the last AV scan started, then method 200 branches from step 215 to step 225 to ensure that all files in the file system are checked. If the virus signature file has not been updated since the last AV scan started, then method 200 progresses from step 215 to step 220 because it is not necessary to scan all files in the file system.

In step 220, the AV software that will perform the batch mode scan of files in physical file system 170 invokes an API call to direct the file system to return all deltas, i.e., differences, between PiTC_{current}_{_{—}}_{scan} and PiTCₚᵣₑᵥᵢₒᵤₛ_{_{—}}_{scan}. Typically, this call is an iterator, which allows a caller to iterate through the files of interest. The AV software calls the API of the file system, to both create a PiTC and return an “iterator” that can be used to enumerate all the files that have changed between a pair of PiTCs. Such an API call can provide an “iterator” capability with a “getNext” type of function to return a next item in a list of items.

Of the deltas reported between PITC_{current}_{_{—}}_{scan} and PiTCₚᵣₑᵥᵢₒᵤₛ_{_{—}}_{scan}, only new and changed files need to be scanned, whereas changes such as a file being moved from one folder to another folder need not be scanned. Note that a file needs to be scanned only if there is a change in the file's content between PiTC_{current}_{_{—}}_{scan} and PiTCₚᵣₑᵥᵢₒᵤₛ_{_{—}}_{scan}, as opposed to there being a difference only between the file's attributes. For example, if the only difference is that the “virus_checked” attribute is FALSE in the PiTCₚᵣₑᵥᵢₒᵤₛ_{_{—}}_{scan} and TRUE in the PiTC_{current}_{_{—}}_{scan}, then the file does not need to be rescanned during the present execution of method 200. Step 220 provides an iteration list indicating new and changed files to be scanned. From step 220, method 200 advances to step 230.

In step 225, the “iterator” capability is used to enumerate and provide a list of all the files in the PiTC of the file system that has been created for the AV scan. From step 225, method 200 progresses to step 230.

In both steps 220 and 225, the iterator could provide an “inode API” type of function, which provides an efficient technique for traversing objects (files, directories, etc.) of interest in a file system.

In step 230, typical to the manner in which an iterator is used, a check is made to determine whether there are more files to scan. Step 230, the first time through, represents the beginning of one or more iterations over the item list provided from either step 220 or step 225. If the item to be examined is a file, as opposed to a folder for example, then it needs to be scanned. If there are more files to be scanned, then method 200 progresses to step 235. If there are not more files to be scanned, then method 200 branches to step 270.

In step 235, the next file to be scanned is acquired. As stated earlier, this is a PiTC of the file, which might already be different from the version of the file in physical file system 170 that is normally available to applications (remotely) for modification, i.e., the active file system. Method 200 then progresses to step 240.

In step 240, a check is made to determine whether the file is to be scanned for viruses. This determination is based on (a) whether the current execution of method 200 is scanning the entire file system and (b) the state of “virus_checked.” in the PiTC_{current}_{_{—}}_{scan} version of the file. Keep in mind that the PiTC_{current}_{_{—}}_{scan} version of the file might be different from the active file system version of the file.

If the current execution of method 200 is NOT scanning the entire file system, and if “virus_checked” is TRUE in the PiTC_{current}_{_{—}}_{scan} version, then the file does not need to be checked in this iteration. This also means that the present PiTC version of the file has already been checked since the last time it was changed (see FIG. 3 and the description of method 300), and the virus signature file has not been changed since the last batch scan, i.e., the last time method 200 was executed. Method 200 therefore loops back from step 240 to step 230 to check the next file, if any, returned by the iterator.

On the other hand, if the current execution of method 200 is scanning the entire file system or if “virus_checked” is FALSE in the PITC_{current}_{_{—}}_{scan} version, then the file does need to be checked and method 200 progresses from step 240 to step 245.

In step 245 the file is scanned for viruses. Any suitable conventional AV software can be employed for the AV scanning. The AV scanning could be performed on NAS server 140, or it can be offloaded to another machine (not shown). As explained below, the AV software and NAS server 140 may be configured to check only files with particular extensions, or to bypass files having particular extensions, which could be an extra check at this point, although not illustrated in FIG. 2. After step 245, method 200 progresses to step 250.

In step 250, a check is made to determine whether the file was found to have a virus. If the file was found to have a virus, then method 200 branches to step 265. If the file was not found to have a virus, then method 200 progresses to step 255.

In step 255, a check is made to determine whether the file has been changed in the active file system since PiTC_{current}_{_{—}}_{scan} was created, i.e., while the virus scan was being performed. This can be achieved, for example, by using an API provided by physical file system 170 that receives as input a file name and a PiTC reference, and returns an indication of whether the file has been changed in the active file system. Keep in mind that PiTC_{current}_{_{—}}_{scan} was created at some time in the past, and that there is a possibility that the file in the active file system may have been changed since the creation of PiTC_{current}_{_{—}}_{scan}. Accordingly, if the file has been changed in the active file system since PiTC_{current}_{_{—}}_{scan} was created, then the file cannot be marked as being virus-free based on the check of the PiTC version, and method 200 loops back from step 255 to step 230, and thus method 200 does not set the “virus_checked” attribute to TRUE. Note that a check performed in the active file system, according to method 300 described in FIG. 3, will determine the value of the “virus_checked” attribute of the file in the active file system.

In step 255, if the check turns out to be FALSE, i.e., the file has not been changed in the active file system since PiTC_{current}_{_{—}}_{scan} was created, then method 200 proceeds to step 260.

In step 260, the “virus_checked” attribute of the file is set to TRUE in the active file system to indicate that the file was scanned and no known virus was detected. Method 200 then loops back to step 230 to check the next file in the iteration list.

Note that in step 260, the “virus_checked” attribute has to be set in the active file system version of the file because method 300 operates on the active file system, and reads and possibly alters the “virus_checked” attribute during an incremental virus checking mode.

The check of step 255 and the action of step 260 are done atomically, i.e., as one compound operation without interference from other activities occurring in system 140. This atomic action is done to prevent a situation where the check in step 255 yields NO, but before the “virus_checked” attribute is set to TRUE in step 260, some other application changes the file making the setting of the “virus_checked” attribute to TRUE invalid. Note that commercial operating systems typically include locking primitives such as “mutex semaphores”, to protect compound actions from interference with other software actions proceeding in parallel inside a computer system.

In step 265, which is executed if a virus was detected in the file, a corrective action is taken. Such corrective action may include, quarantining the file, that is, renaming it or moving it to a special directory, logging the event, and alerting a system administrator. After step 265, method 200 loops back to step 230 to check the next file in the iteration list.

In step 270, which is executed after step 230 has determined that all of the files in the iteration list have been checked, PiTCₚᵣₑᵥᵢₒᵤₛ_{_{—}}_{scan} is deleted, and PITC_{current}_{_{—}}_{scan} is renamed as PiTCₚᵣₑᵥᵢₒᵤₛ_{_{—}}_{scan}. The deletion and renaming operations are executed atomically. Method 200 then progresses to step 275.

In step 275, method 200 ends and control is returned to the administrative command that initiated the batch mode AV scan. Note that the batch mode AV scan can be run periodically using scheduling software typically available in popular operating systems, e.g., “crond” on a Unix platform.

FIG. 3 is a flowchart of a method 300 for running AV software in an incremental mode, in accordance with the present invention. Portions of method 300 are contemplated as being incorporated into the incremental AV checking software provided by an AV software vendor. Incremental AV checking is typically implemented in AV software at an operating system kernel level, where the AV software monitors all file system operations performed on a physical file system, such as physical file system 170.

Method 300 enhances the capabilities of AV software to utilize the batch mode AV checking of method 200. Method 300 also contemplates an enhancement incorporated into physical file system 170, to set the “virus_checked” attribute of a file to FALSE if any data, even a single byte, has been modified.

Method 300 also uses the “virus_checked” attribute. Method 300 involves operations of opening a file (step 305), modifying an open file (step 355), and closing a file (step 365), to allow efficient virus checking on NAS server 140.

Step 305 is the beginning of a subroutine of method 300 relating to an operation of opening a file that is located in the active file system, by a software application. Accordingly, in step 305, a file is opened (for reading or writing) in NAS server 140. Method 300 then proceeds to step 310.

In step 310, a check is made to see if incremental mode AV checking has been administratively configured to run on a file open operation. If incremental mode AV checking has been administratively configured to run on the file open operation, then method 300 proceeds to step 315. If incremental mode AV checking has not been administratively configured to run on the file open operation, then method 300 branches to step 395.

In step 315, method 300 checks whether the virus signature file has been updated since the last batch mode AV scan started, i.e., since the last execution of method 200 started. If the virus signature file has been updated since the last batch mode AV scan started, then method 300 proceeds to step 325 to ensure that the file is definitely scanned, even if it has been scanned before. If the virus signature file has not been updated since the last batch mode AV scan started, then method 300 proceeds to step 320.

In step 320, the “virus_checked” attribute of the file, in the active file system, is checked. If “virus_checked” is FALSE, then method 300 proceeds to step 325. If “virus_checked” is TRUE, then method 300 branches to step 395.

Note that in step 320, if the “virus_checked” attribute is TRUE, method 300 recognizes that the AV batch mode scan of method 200 has already checked the file for viruses. This recognition of the check performed by method 200 improves the efficiency of incremental mode AV checking by allowing it to avoid the overhead of re-checking the file.

In step 325 the file is scanned for viruses. Any suitable conventional AV software can be employed for the AV scanning. The AV scanning could be performed on NAS server 140, or it can be offloaded to another machine (not shown). The AV software and NAS server 140 may be configured to check only files with particular extensions, or to bypass files having particular extensions, which could be an extra check at this point, although not illustrated in FIG. 3. After step 325, method 300 progresses to step 330.

In step 330, a check is made to determine whether the file was found to have a virus. If the file was not found to have a virus, then method 300 progresses to step 335. If the file was found to have a virus, then method 300 branches to step 340.

In step 335, the “virus_checked” attribute of the file is set to TRUE in the active file system to indicate that the file was scanned and no known virus was detected. Method 300 then proceeds to step 395.

In step 340, which is executed if a virus was detected in the file, a corrective action is taken. Such corrective action may include, quarantining the file, that is, renaming it or moving it to a special directory, logging the event, and alerting a NAS system administrator. After step 340, method 300 proceeds to step 395.

Step 355 is the beginning of a subroutine of method 300 relating to an operation of modifying an open file. Step 355 describes a change that would be made in the operation of physical file system 170. Whenever the content of an open file is modified, as opposed to a modification of an attribute of the file, the file system sets the “virus_checked ” attribute of the file to FALSE. The act of setting the “virus_checked” attribute is performed atomically in order to operate cooperatively with method 200 steps 255 and 260. Note that most commercially available file systems support an attribute called “archive” that has similar semantics to control a backup of the file. The “archive” attribute is set to TRUE by the file system code on any change to the file, and is set to FALSE by tape backup software. A key distinction to be drawn between the “virus_checked” attribute and the “archive” attribute is that since the “virus_checked” attribute is related to security, it is absolutely imperative that the attribute not be modifiable by any standard file system API, whereas no such stipulation is critical for the “archive” attribute. After completion of step 355, method 300 proceeds to step 360 for completion.

In step 360, method 300 is completed. More particularly, the subroutine relating to an operation of modifying an open file, as entered through step 355, is complete.

Step 365 is the beginning of a subroutine of method 300 relating to an operation of closing a file. Accordingly, in step 365, a file is closed, with or without any modification since it was opened. Method 300 then proceeds to step 370.

In step 370, a check is made to see if incremental mode AV checking has been administratively configured to run on the file close operation. If incremental mode AV checking has been administratively configured to run on the file close operation, then method 300 branches to step 315, and processing continues in the same manner as for the case of a file open operation. If incremental mode AV checking has not been administratively configured to run on the file close operation, then method 300 branches to 395 for completion since no virus checking is necessary at this point.

In step 395, method 300 is completed. More particularly, the subroutine relating to either opening or closing a file, as entered through step 305 or step 365, respectively, is complete.

AV scan execution may be optimized to run more efficiently for files. For example, a file name extension, e.g., “.c” or “.java”, may represent a file that contains only non-executable program code or source code. Accordingly, the AV program can skip such a file on the basis of its extension, because a virus can only cause damage by running as an executable program. This optimization technique was mentioned earlier in the description of step 245 and step 325.

It should be understood that various alternatives and modifications of the present invention could be devised by those skilled in the art. Nevertheless, the present invention is intended to embrace all such alternatives, modifications and variances that fall within the scope of the appended claims.

What is claimed is:

1. A method for running anti-virus software for a file system that is accessible by a client through a server, said method comprising:
creating a current point-in-time copy (PiTC) of said file system;
determining whether a file in said file system is changed, based on a difference between said current PiTC and an earlier PiTC of said file system; and
determining whether said file is to be examined by said anti-virus software, based on whether said file is changed.

2. The method of claim 1, wherein said client is prohibited from modifying said earlier PiTC and said current PiTC.

3. The method of claim 1, wherein said determining whether said file is to be examined indicates that if said file is not changed, then said file should not be examined.

4. The method of claim 1, wherein said determining whether said file is to be examined indicates that if said file is changed, then said file should be examined.

5. The method of claim 1, further comprising maintaining an attribute for said file to indicate whether said file was examined by said anti-virus software and found to be free of known viruses, wherein said client is prohibited from modifying said attribute.

6. The method of claim 5, wherein said attribute can be read by a software application seeking access to said file, as an indicator of whether said file was examined by said anti-virus software and found to be free of known viruses.

7. The method of claim 6, wherein said software application invokes said anti-virus software in an incremental mode to examine said file, if said attribute does not indicate that said file was examined by said anti-virus software and found to be free of known viruses.

8. The method of claim 1, wherein said method is executed in response to a call for a batch mode execution of said anti-virus software.

9. The method of claim 1, wherein said method is executed by said server.

10. A system for running anti-virus software for a file system that is accessible by a client through a server, said system comprising a processor for:
(a) creating a current point-in-time copy (PiTC) of said file system;
(b) determining whether a file in said file system is changed, based on a difference between said current PiTC and an earlier PiTC of said file system; and
(c) determining whether said file is to be examined by said anti-virus software, based on whether said file is changed.

11. The system of claim 11, wherein said client is prohibited from modifying said earlier PiTC and said current PiTC.

12. The system of claim 10, wherein said determining whether said file is to be examined indicates that if said file is not changed, then said file should not be examined.

13. The system of claim 10, wherein said determining whether said file is to be examined indicates that if said file is changed, then said file should be examined.

14. The system of claim 10,
wherein said processor is also for maintaining an attribute for said file to indicate whether said file was examined by said anti-virus software and found to be free of known viruses, and
wherein said client is prohibited from modifying said attribute.

15. The system of claim 14, wherein said attribute can be read by a software application seeking access to said file, as an indicator of whether said file was examined by said anti-virus software and found to be free of known viruses.

16. The system of claim 15, wherein said software application invokes said anti-virus software in an incremental mode to examine said file, if said attribute does not indicate that said file was examined by said anti-virus software and found to be free of known viruses.

17. The system of claim 10, wherein said processor performs said (a), (b) and (c) in response to a call for a batch mode execution of said anti-virus software.

18. The system of claim 10, wherein said processor is a component of said server.

19. A storage media containing instructions for controlling a processor for running anti-virus software for a file system that is accessible by a client through a server, said storage media comprising:
(a) a program module for controlling said processor to create a current point-in-time copy (PiTC) of said file system;
(b) a program module for controlling said processor to determine whether a file in said file system is changed, based on a difference between said current PiTC and an earlier PiTC of said file system; and
(c) a program module for controlling said processor to determine whether said file is to be examined by said anti-virus software, based on whether said file is changed.

20. The storage media of claim 19, wherein said client is prohibited from modifying said earlier PiTC and said current PiTC.

21. The storage media of claim 19, wherein said program module for controlling said processor to determine whether said file is to be examined indicates that if said file is not changed, then said file should not be examined.

22. The storage media of claim 19, wherein said program module for controlling said processor to determine whether said file is to be examined indicates that if said file is changed, then said file should be examined.

23. The storage media of claim 19, further comprising a program module for controlling said processor to maintain an attribute for said file to indicate whether said file was examined by said anti-virus software and found to be free of known viruses, wherein said client is prohibited from modifying said attribute.

24. The storage media of claim 23, wherein said attribute can be read by a software application seeking access to said file, as an indicator of whether said file was examined by said anti-virus software and found to be free of known viruses.

25. The storage media of claim 24, wherein said software application invokes said anti-virus software in an incremental mode to examine said file, if said attribute does not indicate that said file was examined by said anti-virus software and found to be free of known viruses.

26. The storage media of claim 19, wherein said (a), (b) and (c) are invoked in response to a call for a batch mode execution of said anti-virus software.

27. The storage media of claim 19, wherein said processor is a component of said server.
